(19) United States
(12) Patent Application Publication
(10) Pub. No.: US 2009/0066636 A1
(43) Pub. Date: Mar. 12, 2009

(54) ELECTRO-OPTIC DISPLAY DEVICE AND METHOD OF DRIVING THE SAME

(75) Inventors: Jong-Hee KIM, Seoul (KR); Cheol-Woo PARK, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/180,784

(22) Filed: Jul. 28, 2008

(30) Foreign Application Priority Data
Sep. 6, 2007 (KR) 10-2007-0090426

(51) Int. Cl. G09G 3/34; G09G 3/20

(52) U.S. Cl. 345/107; 345/55

(57) ABSTRACT

Disclosed is an electrophoretic display device including an electrophoretic display panel, a gate driver to supply a scan signal to a gate line of the electrophoretic display panel for a longer time during a refresh period than during a data output period, a data driver to supply at least one of a refresh voltage and a data voltage to a data line of the electrophoretic display panel, and a timing controller to supply a gate control signal and a data control signal to the gate driver and the data driver, respectively, and a method of driving the electrophoretic display device.

### CROSS-REFERENCE TO RELATED APPLICATION

This application claims priority from and the benefit of Korean Patent Application No. 10-2007-0090426, filed on Sep. 6, 2007, which is hereby incorporated by reference for all purposes as if fully set forth herein.

### BACKGROUND OF THE INVENTION

1. Field of the Invention

The present invention relates to an electro-optic display device and a method of driving the same, and more particularly to an electrophoretic display device that may be capable of increasing a refresh time to improve display quality, and a method of driving the same.

2. Discussion of the Background

Electro-optic display devices include a liquid crystal display (LCD) devices, plasma display devices, organic light emitting display (OLED) devices, and electrophoretic display (EPD) devices. Recently, an electrophoretic display (EPD) device, which does not need a backlight assembly to display an image, has been widely developed. The EPD has many advantages such as a wide viewing angle, high reflectivity, easy-to-read characteristics, and lower power consumption.

The EPD device applies an electric field to conductive particles dispersed in a thin-type flexible substrate and changes the polarity of the electric field to display an image.

A sequence during which the EPD device displays an image may include a refresh period and a data output period.

During the data output period, data voltages are supplied to data lines while scan signals are sequentially supplied to gate lines. The scan signals may be distorted by RC delays of the gate lines, which may change the timing at which data signals are supplied. As a result, the display quality of the EPD device may worsen. Accordingly, it may be necessary to compensate for the distortion of the scan signals.

For this purpose, the scan signals may need to be cut off before the RC delay occurs. By doing so, the deterioration of display quality caused by the RC delay may be prevented.

It may not be essential to consider the influences from the RC delay because either a black data signal or a white data signal alone may be supplied during a refresh period. However, when the time required to supply the scan signals during the refresh period decreases due to the RC delay of the scan signals, refreshing can be insufficiently accomplished, and therefore, an operation error, such as image sticking, may occur.

### SUMMARY OF THE INVENTION

The present invention provides an EPD device that may be capable of increasing supplying time of scan signals during a refresh period to prevent deterioration of display quality, and a method of driving the EPD device.

Additional features of the invention will be set forth in the description which follows, and in part will be apparent from the description, or may be learned by practice of the invention.

The present invention discloses an electrophoretic display device including an electrophoretic display panel, a gate driver to supply a scan signal to a gate line of the electrophoretic display panel for a longer time during a refresh period than during a data output period, a data driver to supply at least one of a refresh voltage and a data voltage to a data line of the electrophoretic display panel, and a timing controller to supply a gate control signal and a data control signal to the gate driver and the data driver, respectively.

The present invention also discloses a method of driving an electrophoretic display device including supplying a scan signal to a subsequent gate line simultaneously with the turning off of the scan signal of a previous gate line during a refresh period, supplying a refresh voltage to a data line in response to the supplied scan signal during the refresh period, supplying the scan signal to the subsequent gate line after a delay from the turning off of the scan signal of the previous gate line during a data output period; and supplying a data voltage to the data line in response to the supplied scan signal during the data output period.

The present invention also discloses an electro-optic display device, comprising: an electro-optic display panel; a gate driver to supply a scan signal to a gate line of the electro-optic display panel during a refresh period and during a data output period; a data driver to supply at least one of a refresh voltage and a data voltage to a data line of the electro-optic display panel; and a timing controller to supply a gate control signal comprising a gate start pulse, a gate shift clock and a output control signal to the gate driver and to supply a data control signal comprising a data start pulse, a load signal to the data driver, wherein the timing controller supplies the output control signal to the gate dirvier during the data ouput period.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of an EPD device according to an exemplary embodiment of the present invention.

FIG. 2 is a cross section view of the EPD panel shown in FIG. 1.

FIG. 3 is a view showing a sequence for driving an EPD device according to an exemplary embodiment of the present invention.

FIG. 4 is a timing diagram of scan signals supplied from a gate driver during a refresh period shown in FIG. 3.

FIG. 5 is a timing diagram of scan signals supplied from a gate driver during a data output period shown in FIG. 3.

FIG. 6 is a block diagram of an EPD device according to another exemplary embodiment of the present invention.

FIG. 7 is a view showing a comparison between a refresh period when a previously supplied data signal is a black data signal and another refresh period when the previously supplied data signal is a gray signal in the EPD device shown in FIG. 6.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative size of layers and regions may be exaggerated for clarity. Like reference numerals in the drawings denote like elements. Hereinafter, exemplary embodiments of the present invention will be described in more detail with reference to accompanying drawings.

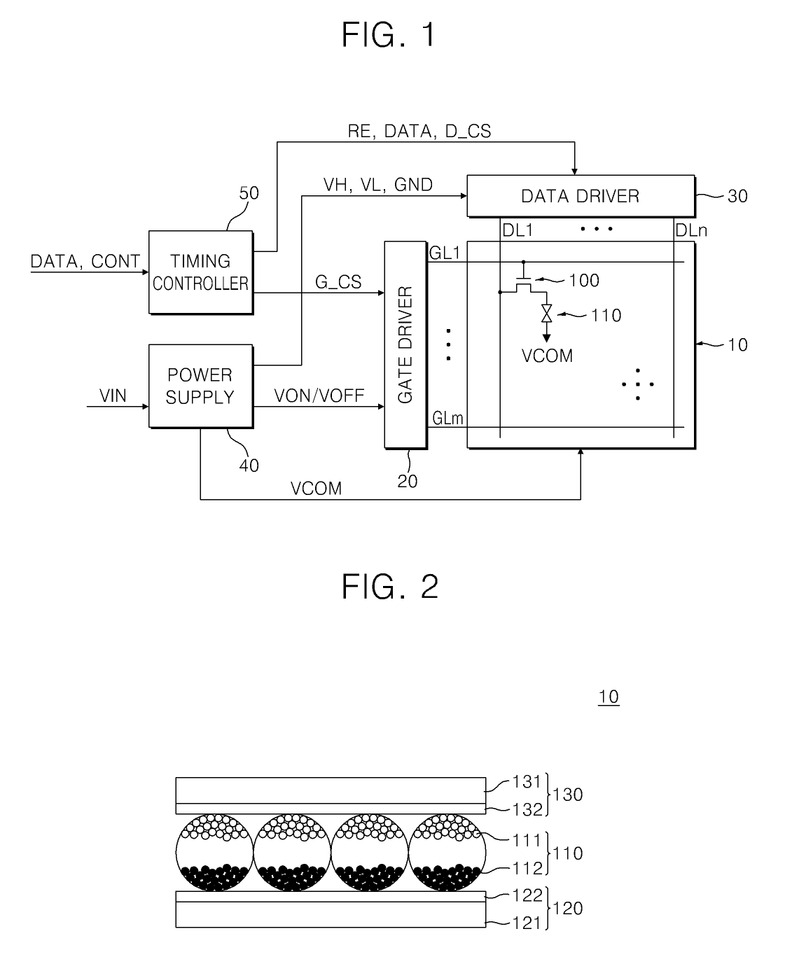

FIG. 1 is a block diagram of an EPD device according to an exemplary embodiment of the present invention, and FIG. 2 is a cross section view of an EPD panel shown in FIG. 1. It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Referring to FIG. 1 and FIG. 2, the EPD device includes an EPD panel 10, a timing controller 50, a power supply 40, a gate driver 20, and a data driver 30.

The EPD panel 10 includes a first substrate 120 and a second substrate 130 that are attached to each other. Micro-capsules 110 are disposed between the first and second substrates 120 and 130.

Each micro-capsule 110, which may be a sphere or another form similar to a sphere, contains black and white conductive particles 111 and 112. The white conductive particles 111 may be negatively charged and the black conductive particles 112 may be positively charged, or vice versa.

When a voltage is applied between two electrodes that face each other, an electric field is generated by the potential difference between the electrodes. The white conductive particles 111 and black conductive particles 112 respectively move toward oppositely charged electrodes along the electric field. The conductive particles 111 and 112 in the micro-capsules 110 reflect or absorb externally incident light to display a white image or a black image.

The first substrate 120 includes a first insulation substrate 121, gate lines GL1 to GLm, data lines DL1 to DLn, a thin film transistor (TFT) 100, and a pixel electrode 122.

The first insulation substrate 121 may include, for example, a thin and flexible plastic material.

The gate lines GL1 to GLm are provided on the first insulation substrate 121. The data lines DL1 to DLn cross the gate lines GL1 to GLm, and an insulating layer is interposed therebetween.

A TFT 100 is provided in each pixel region. Each TFT 100 includes a gate electrode, a semiconductor layer, a source electrode, and a drain electrode. The gate electrode is connected to the gate line, the source electrode is connected to the data line, and the drain electrode is connected to the pixel electrode 122. The semiconductor layer may include an organic material, amorphous silicon, or polycrystalline silicon.

The TFT 100 supplies a voltage from the data line to the pixel electrode 122 when a scan signal is applied to the gate line.

The pixel electrode 122 drives the conductive particles 111 and 112 with data voltages.

The second substrate 130 includes a second insulation substrate 131 and a common electrode 132.

The second insulation substrate 131 may include, for example, a thin and flexible plastic material, similar to the first insulation substrate 121.

The common electrode 132 is provided over the entire surface of the second insulation substrate 131. The common electrode 132 receives a common voltage VCOM.

Each of the first insulation substrate 121 and the second insulation substrate 131 may include an adhesive layer (not shown) including a film coated with an adhesive material on both surfaces. The micro-capsule 110 is attached and fixed to one surface of the adhesive layer, and the pixel electrode 122 and common electrode 132 are attached to the other surface thereof.

The conductive particles 111 and 112 are driven by data signals received from the data driver 30 when the scan signals are supplied from the gate driver 20.

Although micro-capsules 110 have been used for the EPD panel 10 in FIG. 1 and FIG. 2, the present invention is not limited thereto, and liquid crystal or other materials that have memory characteristics may also be used.

The power supply 40 generates a high voltage VH, a low voltage VL, a ground voltage GND, a gate-on voltage VON, a gate-off voltage VOFF, and a common voltage VCOM using an externally supplied input voltage VIN. The common voltage VCOM is supplied to the common electrode 132 of the EPD panel 10 and the gate-on and gate-off voltage VON and VOFF are supplied to the gate driver 20. The high voltage VH, the low voltage VL, and the ground voltage GND are supplied to the data driver 30.

The timing controller 50 generates a gate control signal G_CS and a data control signal D_CS through an externally supplied data signal DATA and a control signal CONT. The timing controller 50 supplies the gate control signal G_CS to the gate driver 20 and the data control signal D_CS to the data driver 30.

The data control signal D_CS includes a data start pulse to drive a first data line DL1 and a load signal to apply a data voltage to a corresponding data line DL. The timing controller 50 supplies a data signal DATA to the data driver 30 during a data output period.

The timing controller 50 generates different gate control signals G_CS in a refresh period and a data output period.

More specifically, the timing controller 50 generates the gate control signal G_CS including a gate start pulse and a gate shift clock during the refresh period, while the timing controller 50 generates the gate control signal G_CS including an output control signal in addition to the gate start pulse and gate shift clock during the data output period.

The gate start pulse, which indicates a start of a frame, enables a scan signal to be supplied to a first gate line GL1 of each frame. The gate shift clock enables scan signals to be sequentially supplied to the gate lines GL1 to GLm.

The output control signal prevents a scan signal from overlapping with another scan signal by adjusting the pulse width of the scan signal supplied during the data output period.

The timing controller 50 supplies a refresh signal RE to the data driver 30 during the refresh period. The refresh signal RE may be mainly a white data signal, but may include a black or gray data signal.

When the gate control signal G_CS and gate-on and gate-off voltages VON and VOFF are supplied from the timing controller 50 and power supply 40, respectively, the gate driver 20 sequentially supplies scan signals to the gate lines GL1 to GLm.

The gate driver 20 supplies the scan signals for a longer time during the refresh period than during the data output period. That is, the time for which the scan signals are supplied is lengthened so that a refresh voltage can be applied for a longer time. As the time for which the refresh voltage is supplied increases during a refresh period, the charging time of the refresh voltage correspondingly becomes longer, and therefore, the number of frames during which the whole refresh voltage is supplied may be reduced.

During the data output period, a subsequent scan signal to be supplied to the next gate line is delayed by an output control signal OE that is supplied by the timing controller 50. Accordingly, a signal distortion caused by RC delays may be reduced.

The data driver 30 receives the data control signal D_CS, the data signal DATA, and the refresh signal RE from the timing controller 50 and the high voltage VH, the low voltage VL, and the ground voltage GND from the power supply 40 to output a refresh voltage or data voltage to the data lines DL1 to DLn.

The data driver 30 supplies the refresh voltage to the data lines DL1 to DLn in response to the refresh signal RE during the refresh period. The data driver 30 supplies either the high voltage VH or the low voltage VL as the refresh voltage.

The data driver 30 supplies the data lines DL1 to DLn with a data voltage corresponding to the data signal DATA during the data output period. When the EPD device displays a black image, a high voltage VH or a low voltage VL is supplied to a corresponding pixel. The number of times a high voltage VH is supplied may be adjusted to display a gray image.

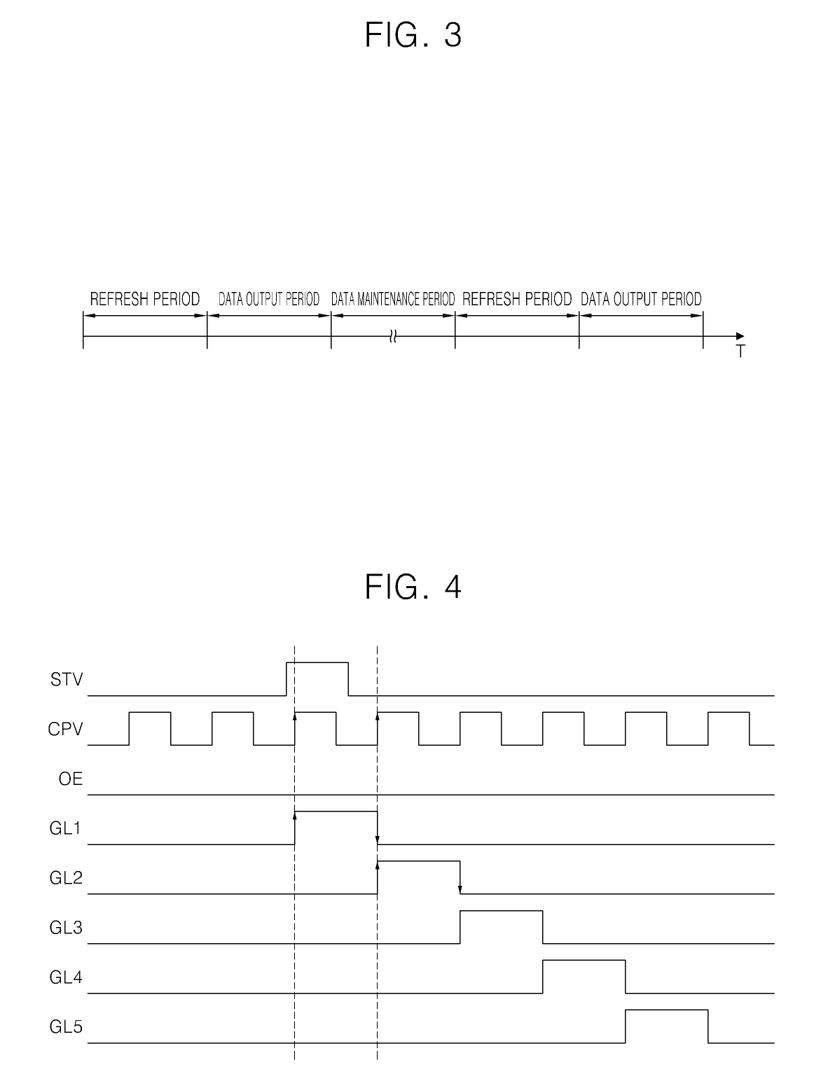

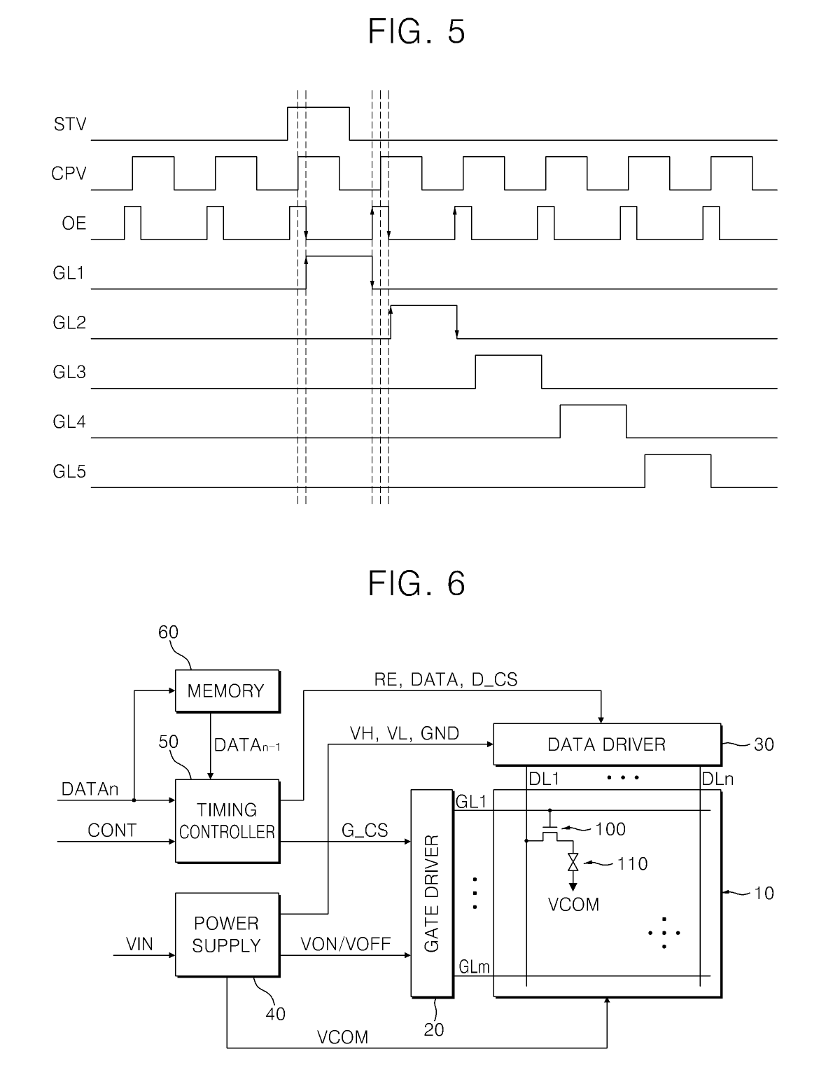

A method of driving an EPD device according to an exemplary embodiment of the present invention will be described with reference to FIG. 3, FIG. 4, and FIG. 5.

FIG. 3 is a view showing a sequence for driving an EPD device according to an exemplary embodiment of the present invention, FIG. 4 is a timing diagram of scan signals supplied from a gate driver during a refresh period shown in FIG. 3, and FIG. 5 is a timing diagram of scan signals supplied from a gate driver during a data output period shown in FIG. 3.

Referring to FIG. 3, the EPD panel is refreshed when a data signal DATA is externally supplied. Next, a data voltage is supplied to the refreshed EPD panel to display an image. The displayed image can continuously remain on the EPD panel during a data maintenance period even if the data voltage supply ceases.

During the refresh period, all images previously displayed at the EPD panel are deleted when a data signal is externally supplied.

A low voltage of −15 volts may be used for the refresh voltage to make the EPD panel display a full white image. A high voltage of +15 volts may be used to display a full black image on the EPD panel.

The refresh voltage may be supplied for several or several tens of frames during the refresh period. The refresh voltage may need to be applied several times to the EPD panel to remove the previously displayed image if the driving speed of the micro-capsules is slow.

Voltages that have polarity opposite to each other may be applied to the EPD panel during the refresh period to prevent the pixel electrode from being charged with a DC voltage. That is, a high voltage may be applied for a prescribed period of a frame, and then a low voltage may be applied for a next period. For example, assuming that 20 frames are assigned for a refresh period, a high voltage may be applied during the first 10 frames and a low voltage may be applied during the remaining 10 frames.

When refreshing is complete, a data voltage is supplied to the EPD panel during a data output period. The data voltage that is converted from an externally supplied data signal is applied to the EPD panel for several or several tens of frames. The data voltage may be any one of a high voltage, a low voltage, and a ground voltage. For example, when a black image is displayed at a pixel region, a high voltage is applied to the corresponding pixel region for every frame of the data output period, so that black conductive particles may move toward the common electrode. To display a gray image, the high voltage is not supplied to the EPD panel for each entire frame, but rather is supplied for a part of each frame.

A period (not shown) to output a negative image may be added between the refresh period and data output period.

Although the data voltage is no longer supplied when all data has been displayed, the data still remains. This originates from a memory property of the EPD device, by which the conductive particles may remain at their last state.

FIG. 4 is a timing diagram of scan signals supplied from a gate driver during the refresh period shown in FIG. 3.

Referring to FIG. 4, after a gate start pulse STV has been supplied, scan signals are sequentially supplied to the gate lines GL1 to GLm in synchronization with a gate shift clock CPV.

More specifically, the timing controller 50 sequentially supplies scan signals to the gate lines GL1 to GLm by supplying the gate start pulse STV and gate shift clock CPV to the gate driver 20. The gate start pulse STV serves as a signal to drive a first gate line GL1. Therefore, a scan signal is not generated from the gate driver 20 without the application of the gate start pulse STV even though the gate shift clock CPV is continually supplied.

The first scan signal that is applied to the first gate line GL1 is output in synchronization with the gate shift clock CPV after the application of the gate start pulse STV. The first scan signal is applied for one period of the gate shift clock CPV. More specifically, when a gate shift clock CPV increases, the first scan signal increases accordingly and when the next gate shift clock CPV increases, the first scan signal decreases. When the next gate shift clock CPV increases, the second scan signal supplied to the second gate line GL2 increases accordingly. As such, when the first scan signal decreases, the second scan signal increases without any time interval.

While the scan signals are supplied to the gate lines GL1 to GLm during the refresh period, either a white data signal or a black data signal is supplied to the data lines DL1 to DLn. That is, either a white data signal or a black data signal is continually supplied to the EPD panel during the refresh period so that the EPD panel may represent a data signal during a subsequent data output period. In an exemplary embodiment of the present invention, a white data signal is output so that the EPD panel may display a full white image during the refresh period. Depending on the type of data signal, however, the EPD panel may display a full black image during the refresh period or a full black image during a part of the refresh period and a full white image during the other part of the refresh period.

During the refresh period, a refresh voltage is supplied from the data driver to the EPD panel while scan signals are supplied to the gate lines to display a full white image. Because the driving speed of the micro-capsules is very slow, a scan signal is supplied to a gate line several times, and a white data signal is supplied from the data driver to the EPD panel, so that the pixel electrode is charged several times whenever the scan signal is supplied to the EPD panel. Accordingly, the white conductive particles and black conductive particles move toward the common electrode and the pixel electrode, respectively, due to the white data signal, so that a full white image can be displayed by the EPD panel.

As a result, although RC delays of the scan signals occur at the gate lines during the refresh period, either a black data signal or a white data signal is supplied to the EPD panel only during a constant frame, and therefore, the EPD panel may not be negatively affected by RC delays.

FIG. 5 is a timing diagram of scan signals supplied from a gate driver during a data output period shown in FIG. 3.

Referring to FIG. 5, after a gate start pulse STV is supplied, scan signals are sequentially supplied to the gate lines GL1 to GLm in synchronization with a gate shift clock CPV and an output control signal OE.

A data voltage is supplied to the EPD panel during the data output period to display an image. A period when the scan signals are supplied at data output period is set to be shorter than at the refresh period.

After refreshing is complete, the gate driver sequentially supplies scan signals to the gate lines GL1 to GLm using the gate start pulse STV, gate shift clock CPV, and the output control signal OE. During the data output period, the scan signal increases when the output control signal OE decreases within a period of the gate shift clock CPV and decreases when the subsequent output control signal OE increases. No scan signals are supplied between the time when a first scan signal is supplied to the first gate line GL1 and the time when a second scan signal is supplied to the second gate line GL2. That is, the second scan signal is delayed by the width of the output control signal OE after the first scan signal decreases. Accordingly, it may be possible to remove cross-talk caused by superposition of scan signals that occurs due to the RC delays.

In an EPD panel having super extended graphics array (SXGA) resolution that is driven with a frequency of 60 Hz, for example, a scan signal is supplied to a gate line for 15.67 □s. Since the pulse width of the output control signal OE that is used to eliminate cross-talk induced by RC delays is about 4 □s, the scan signal is actually supplied for 11.67 □s. Accordingly, unless the gate output control signal OE is output during a refresh period, the scan signal is supplied for 15.67 □s, and therefore, the high-level section of the scan signal is lengthened by about 25%. As a consequence, the refreshing time of the EPD device may be diminished.

If the refreshing time is reduced, the power consumption may be decreased and images may be more rapidly displayed than in a conventional EPD device, thus improving the display properties and extending the data output time.

Referring to FIG. 6, the EPD device includes an EPD panel 10, a timing controller 50, a power supply 40, a gate driver 20, a data driver 30, and a memory 60.

The EPD panel 10, the power supply 40, the gate driver 20, and the data driver 30 shown in FIG. 6 are similar to those of FIG. 1, and therefore, repetitive descriptions thereof will be omitted.

Here, the response time of the micro-capsules corresponds to several milliseconds to several hundreds milliseconds, and therefore, the micro-capsules do not react immediately when the data voltage is applied to the pixel electrode. At this time, since it takes several milliseconds to several hundreds of milliseconds to change the color of a pixel from white to black, the data voltage may be applied several times to the pixel electrode over a period of time. As described above, a gray color may be displayed by decreasing the number of times of a high voltage is supplied as compared to a case of displaying black color.

The refresh period necessary to represent colors other than black, such as gray or white, may be shorter than the refresh period necessary to represent black color. It may be possible to adjust the number of frames, i.e. refreshing time, for each of black, white, and gray by determining which of the black, white, and gray is displayed by the EPD panel 10.

For this purpose, the EPD device may further include the memory 60 and timing controller 50 to determine which of black, white, and gray is displayed due to the previous data signal.

The memory 60 stores an externally supplied data signal DATA. The memory 60 applies a previously stored data signal DATAn-1 to the timing controller 50 when the next data signal DATA is input.

The timing controller 50 calculates the maximum data value of the data signal DATAn-1 and controls the supplying time of a refresh signal according to the calculated maximum data value.

For example, the timing controller 50 outputs a refresh signal to maximize the refreshing time when the maximum data value corresponds to black color, and a refresh signal to minimize the refreshing time when the maximum data value corresponds to white color. The refreshing time is determined between the refreshing time for black and the refreshing time for white when the maximum data value corresponds to gray.

When the maximum data value corresponds to black, the image displayed by previous data signal may be refreshed with white by maximizing the refreshing time in order to prevent deterioration of display quality. When the maximum data value corresponds to white, images may be displayed immediately by inputting the data voltage with the minimized refreshing time or without refreshing.

When the maximum data value corresponds to gray, the refreshing time may be adjusted according to the gray level. For example, when the gray level amounts to 50% of black color, refreshing may be carried out for half of the maximum refreshing time. When the maximum data value corresponds to gray, the refreshing time may be actively adjusted according to the gray level.

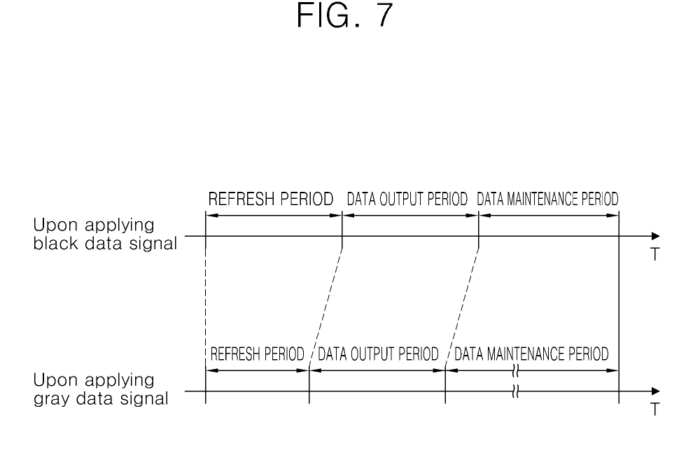

As shown in FIG. 7, the refresh period for gray is shorter than that for black color, when the maximum data value corresponds to black and gray but not to white.

When a refresh period is set up differently for each of black, white, and gray, the refreshing time may be diminished, thus the reducing power consumption and the response time of the EPD device.

As mentioned above, the refreshing time may be sufficiently provided by supplying scan signals in a normal manner without considering the effects of RC delays during a refresh period, and therefore, it may be possible to prevent deterioration of the display qualify of the EPD device and to decrease power consumption.

The scan signals are supplied in synchronization with output control signals during a data output period, and therefore, it may be possible to prevent cross-talk from occurring due to RC delays.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An electrophoretic display device, comprising:
an electrophoretic display panel;
a gate driver to supply a scan signal to a gate line of the electrophoretic display panel for a longer time during a refresh period than during a data output period;
a data driver to supply at least one of a refresh voltage and a data voltage to a data line of the electrophoretic display panel; and
a timing controller to supply a gate control signal and a data control signal to the gate driver and the data driver, respectively.

2. The electrophoretic display device of claim 1, wherein
the timing controller outputs a gate start pulse and a gate shift clock during the refresh period, and further outputs an output control signal to control an output of the scan signal, in addition to the gate start pulse and the gate shift clock, during the data output period.

3. The electrophoretic display device of claim 2, wherein the scan signal supplied during the refresh period is synchronized with the gate shift clock, and the scan signal supplied during the data output period is synchronized with the output control signal.

4. The electrophoretic display device of claim 3, wherein the scan signal supplied during the data output period is delayed by a pulse width of the output control signal and supplied to a next gate line.

5. The electrophoretic display device of claim 1, further comprising:
a power supply to supply a gate-on voltage and a gate-off voltage to the gate driver, and a high voltage, a low voltage, and a ground voltage to the data driver.

6. The electrophoretic display device of claim 5, wherein the data driver supplies at least one of the high voltage and the low voltage from the power supply as the refresh voltage during the refresh period.

7. The electrophoretic display device of claim 6, wherein the high voltage is supplied for a first part of the refresh period and then the low voltage is supplied for a second part of the refresh period.

8. The electrophoretic display device of claim 3, wherein the scan signal is sequentially supplied to the gate lines without delay between scan signals of adjacent gate lines during the refresh period.

9. The electrophoretic display device of claim 1, further comprising:
a memory to store an externally supplied data signal, wherein the data signal is supplied to the timing controller when a next data signal is input.

10. The electrophoretic display device of claim 9, wherein the timing controller calculates a maximum data value from the data signal supplied from the memory, and controls a time for which the refresh voltage is supplied depending on the maximum data value.

11. The electrophoretic display device of claim 10, wherein the refresh voltage comprises at least one of a high voltage and a low voltage that are supplied for a constant time.

12. A method of driving an electrophoretic display device, comprising:
supplying a scan signal to a subsequent gate line simultaneously with the turning off of the scan signal of a previous gate line during a refresh period;
supplying a refresh voltage to a data line in response to the supplied scan signal during the refresh period;
supplying the scan signal to the subsequent gate line after a delay from the turning off of the scan signal of the previous gate line during a data output period; and
supplying a data voltage to the data line in response to the supplied scan signal during the data output period.

13. The method of claim 12, wherein the scan signal is supplied for a longer time during the refresh period than during the data output period.

14. The method of claim 13, wherein when the scan signal that is supplied to a first gate line decreases, the scan signal that is
supplied to a second gate line subsequent to the first gate line increases during the refresh period.

15. The method of claim 12, wherein supplying a refresh voltage comprises,
supplying a high voltage to the data line for a first constant time, and
supplying a low voltage to the data line for a second constant time identical to the first constant time.

16. The method of claim 12, wherein
the scan signal is sequentially supplied to the gate lines in synchronization with a gate shift clock during the refresh period, and
the scan signal is sequentially supplied to the gate lines in synchronization with an output control signal during the data output period.

17. The method of claim 16, wherein the scan signal that is supplied to the previous gate line during the data ouput period is delayed by a pulse width of the output control signal and supplied to the subsequent gate line.

18. The method of claim 12, further comprising:
storing an externally supplied data signal;
calculating a maximum data value of the data signal; and
adjusting the refresh period depending on the maximum data value.

19. The method of claim 18, wherein adjusting the refresh period comprises:
maximizing a length of the refresh period when the maximum data value corresponds to black;
minimizing the length of the refresh period when the maximum data value corresponds to white; and
when the maximum data value corresponds to gray color, setting a length of the refresh period to be between the maximum length and the minimum length.

20. An electro-optic display device, comprising:
an electro-optic display panel;
a gate driver to supply a scan signal to a gate line of the electro-optic display panel during a refresh period and during a data output period;
a data driver to supply at least one of a refresh voltage and a data voltage to a data line of the electro-optic display panel; and
a timing controller to supply a gate control signal comprising a gate start pulse, a gate shift clock and a output control signal to the gate driver and to supply a data control signal comprising a data start pulse, a load signal to the data driver,
wherein the timing controller supplies the output control signal to the gate dirvier during the data ouput period.
